(19) United States
(12) Patent Application Publication
(10) Pub. No.: US 2023/0249806 A1
(43) Pub. Date: Aug. 10, 2023

(54) SELF-TAXIING APPARATUS FOR AIRCRAFT

(71) Applicant: HYUNDAI WIA CORPORATION, Changwon-si (KR)

(72) Inventor: Seok Nam SHIN, Changwon-si (KR)

(21) Appl. No.: 17/807,537

(22) Filed: Jun. 17, 2022

(30) Foreign Application Priority Data
Feb. 8, 2022 (KR) 10-2022-0016007

(51) Int. Cl. B64C 25/40; B64D 27/26; B64C 25/34; B64C 25/58

(52) U.S. Cl. CPC B64C 25/405; B64D 27/26; B64C 25/34; B64C 25/58

(57) ABSTRACT

Disclosed is a self-taxiing apparatus for an aircraft, the self-taxiing apparatus including an aircraft support body configured to support a body of an aircraft in a state in which the body of the aircraft is spaced apart from a ground surface, the aircraft support body having a motor mounting unit provided at a lower end thereof, an electric motor mounted in the motor mounting unit, a cover fixedly coupled to the motor mounting unit and configured to protect the electric motor, and an aircraft wheel configured to roll in a state of being in contact with the ground surface.

### CROSS-REFERENCE TO RELATED APPLICATION

This application claims priority from and the benefit of Korean Patent Application No. 10-2022-0016007, filed on Feb. 8, 2022, which is hereby incorporated by reference for all purposes as if set forth herein.

### BACKGROUND

### Field

The present disclosure relates to an apparatus provided in an aircraft, and more particularly, to a self-taxiing apparatus for an aircraft, which provides power for moving an aircraft stationary on the ground to a runway.

### Discussion of the Background

Before taking off from an airport, an aircraft needs to move from a hangar or gate along a taxiway to a runway on which the aircraft may run at high speed. In addition, after landing on the runway of the airport, the aircraft needs to move to the hangar or gate along the taxiway.

The aircraft is moved on the ground by being towed by a special vehicle such as a tug or towing car or the aircraft moves by using thrust generated by an engine mounted in the aircraft. When the special vehicle, such as the tug or towing car, is broken down or the number of available special vehicles is insufficient even though the special vehicle needs to be used to move the aircraft, the takeoff and landing control cannot be properly performed.

In general, the engine mounted in the aircraft generates thrust by igniting and combusting aviation fuel and is set to exhibit optimal combustion efficiency when generating high thrust. For this reason, when the aircraft moves on the ground by using the thrust generated by the engine mounted in the aircraft, the engine not only inefficiently consumes an excessive amount of aviation fuel but also produces a considerably large amount of combustion products such as carbon dioxide and nitrogen oxide, which causes environmental pollution.

The background technology of the present disclosure is disclosed in Korean Patent Application Laid-Open No. 10-2016-0141761 (published on Dec. 9, 2016 and entitled ‘Drive System for Aircraft Landing Gear’).

### SUMMARY

Various embodiments are directed to a self-taxiing apparatus for an aircraft that moves an aircraft on the ground by using power of an electric motor embedded in the aircraft without depending on a special vehicle.

Various embodiments are also directed to a self-taxiing apparatus for an aircraft that generates power for moving an aircraft on the ground without producing environmental pollutants.

In an embodiment, a self-taxiing apparatus for an aircraft includes: an aircraft support body configured to support a body of an aircraft in a state in which the body of the aircraft is spaced apart from a ground surface, the aircraft support body having a motor mounting unit provided at a lower end thereof; an electric motor mounted in the motor mounting unit; a cover fixedly coupled to the motor mounting unit and configured to protect the electric motor; an aircraft wheel configured to roll in a state of being in contact with the ground surface, the aircraft wheel including an annular tire and a tire support wheel configured to fix and support the tire; a driving shaft configured to be rotated by a rotation of a motor shaft of the electric motor, the driving shaft being configured to penetrate the cover and the tire support wheel; a driving power transmission plate having one end fixedly coupled to the driving shaft and the other end fixedly coupled to the tire support wheel, the driving power transmission plate being configured to transmit a rotation of the driving shaft to the aircraft wheel; and a landing shaft configured to support the tire support wheel by means of a bearing so that the tire support wheel is rotatable, the landing shaft being fixedly coupled to the cover and configured not to rotate despite the rotation of the driving shaft.

The landing shaft may include a tubular portion configured to surround the driving shaft, extending while penetrating the tire support wheel, and separated from the driving shaft and the driving power transmission plate, and the bearing may be interposed between an outer peripheral surface of the tubular portion and an inner peripheral surface of a hollow portion formed in the tire support wheel so that the landing shaft penetrates the hollow portion.

Impact, which is applied to the aircraft wheel when the aircraft lands and the aircraft wheel collides with the ground surface, may be sequentially transmitted to the bearing, the landing shaft, the cover, and the motor mounting unit but not transmitted to the electric motor through the driving shaft.

The self-taxiing apparatus according to the present disclosure may further include: a clutch disposed in the cover and configured to be selectively connected to the driving shaft and selectively transmit a rotational force of the motor shaft to the driving shaft, and the clutch may not be connected to the driving shaft when the aircraft lands, such that the impact applied to the aircraft wheel is not transmitted to the clutch through the driving shaft.

The self-taxiing apparatus according to the present disclosure may further include a speed reducer provided in the cover, disposed between the electric motor and the clutch, and configured to reduce a rotational speed of the motor shaft.

A concave-convex portion may be formed on an outer peripheral surface of one end of the driving shaft, and a concave-convex portion may be formed on an inner peripheral surface of one end of the driving power transmission plate and engage with the concave-convex portion formed on the outer peripheral surface of the driving shaft, such that the driving shaft and the driving power transmission plate are coupled to each other by means of a spline structure.

The motor mounting unit may include: a motor groove into which the electric motor is fitted; and a harness through-hole formed through the motor groove and an outer peripheral surface of the motor mounting unit, and a harness configured to supply electric power to the electric motor may enter the motor groove through the harness through-hole from the outside of the motor mounting unit and be conductively connected to the electric motor.

The aircraft support body may have a pair of motor mounting units, and a pair of electric motors, a pair of covers, a pair of aircraft wheels, a pair of driving shafts, a pair of driving power transmission plates, and a pair of landing shafts may be symmetrically provided with respect to the aircraft support body.

According to the present disclosure, the self-taxiing apparatus for an aircraft may move the aircraft on the ground by using the power of the electric motor mounted in the aircraft without using a special vehicle such as a tug or towing car. Therefore, it is possible to prevent a delay of takeoff and landing of the aircraft in the airport even though the special vehicle is not available. In addition, the aircraft may be moved on the ground only by the power of the electric motor, which emits no environmental pollutants. Therefore, environmental pollution is inhibited.

According to the present disclosure, the electric motor is mounted in the motor mounting unit and protected by the cover. Further, the impact, which is applied to the aircraft wheel when the aircraft lands, is sequentially transmitted to the cover and the aircraft support body through the landing shaft but not transmitted to the electric motor through the driving shaft. As a result, even though the aircraft repeatedly takes off and lands, a defective operation of and damage to the self-taxiing apparatus for an aircraft are inhibited, and durability is improved.

### BRIEF DESCRIPTION OF THE DRAWINGS

FIG. 1 is a perspective view of a self-taxiing apparatus for an aircraft according to an embodiment of the present disclosure.

FIG. 2 is an exploded perspective view illustrating the self-taxiing apparatus for an aircraft illustrated in FIG. 1 when viewed from one side.

FIG. 3 is an exploded perspective view illustrating the self-taxiing apparatus for an aircraft illustrated in FIG. 1 when viewed from the other side.

FIG. 4 is a cross-sectional view taken along line IV-IV in FIG. 1.

FIG. 5 is a cross-sectional view taken along line V-V in FIG. 4.

### DETAILED DESCRIPTION OF EMBODIMENTS

Hereinafter, a self-taxiing apparatus for an aircraft according to an embodiment of the present disclosure will be described in detail with reference to the accompanying drawings. The terminologies used in the present specification are used to appropriately describe an embodiment of the present disclosure and may vary depending on the intention of a user or operator or on usual practice in the art to which the present disclosure pertains. Therefore, the definition of the terms should be made on the basis of the entire contents of the present specification.

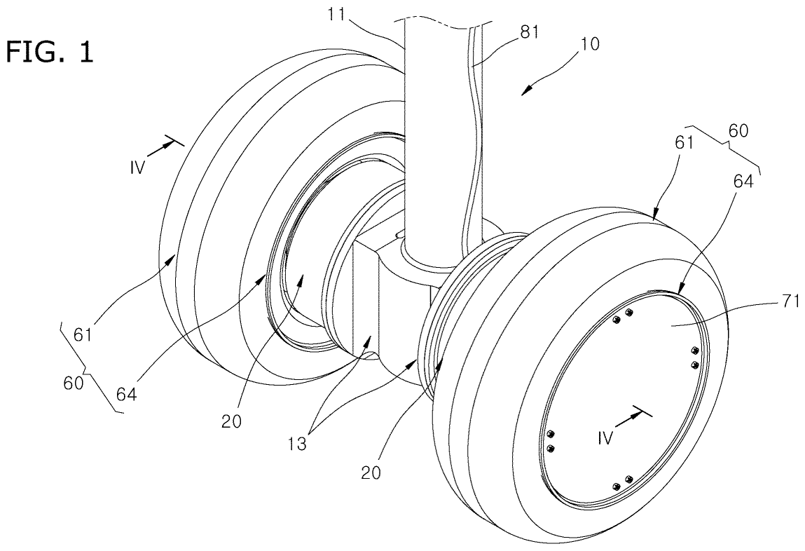

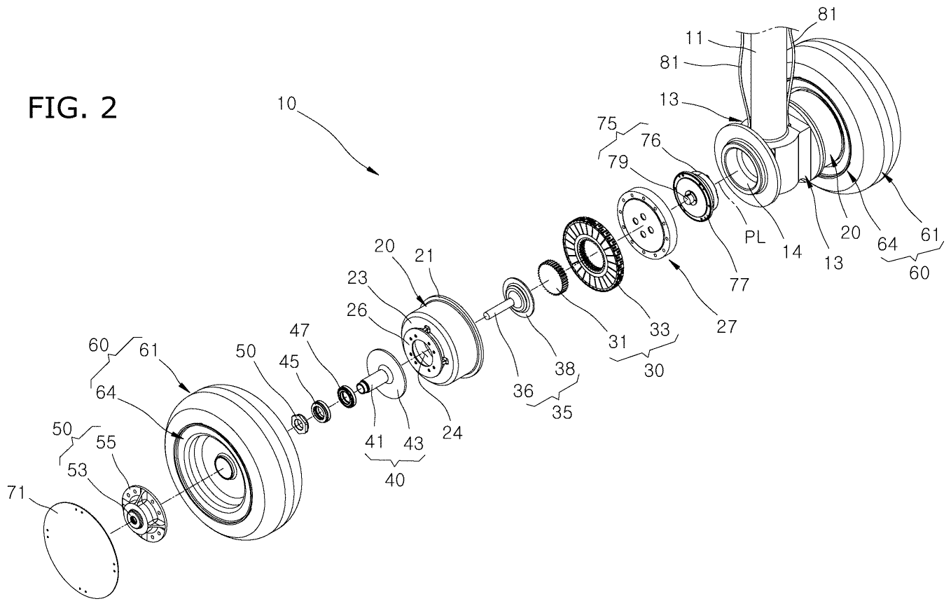

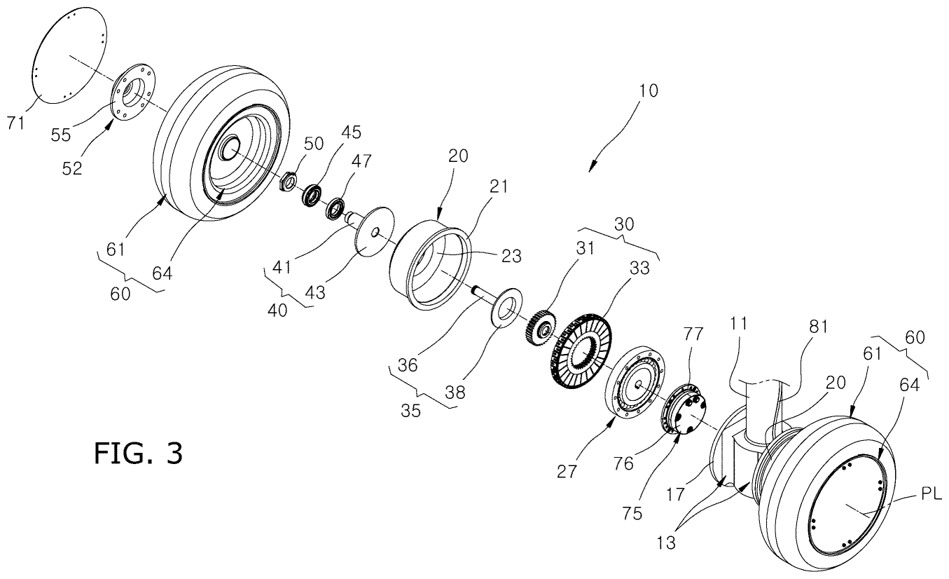

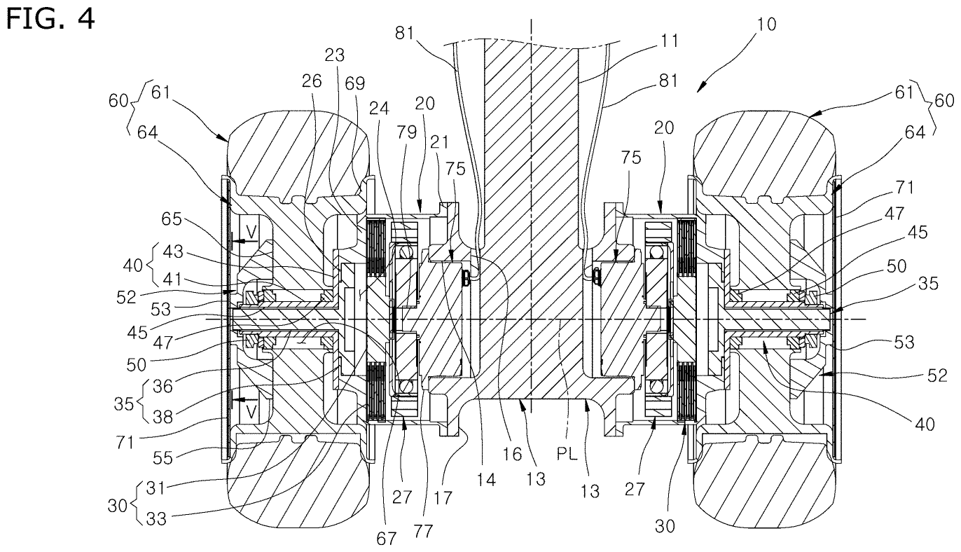

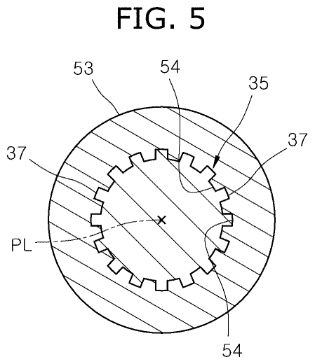

FIG. 1 is a perspective view of a self-taxiing apparatus for an aircraft according to an embodiment of the present disclosure, FIG. 2 is an exploded perspective view illustrating the self-taxiing apparatus for an aircraft illustrated in FIG. 1 when viewed from one side, FIG. 3 is an exploded perspective view illustrating the self-taxiing apparatus for an aircraft illustrated in FIG. 1 when viewed from the other side, FIG. 4 is a cross-sectional view taken along line IV-IV in FIG. 1, and FIG. 5 is a cross-sectional view taken along line V-V in FIG. 4. Referring to FIGS. 1 to 5, a self-taxiing apparatus 10 for an aircraft according to an embodiment of the present disclosure serves to move an aircraft on the ground by using its own power instead of moving the aircraft on the ground by using towing power of a special vehicle such as a tug or towing car.

The self-taxiing apparatus 10 for an aircraft includes an aircraft support body 11, aircraft wheels 60, an electric motor 75, a cover 20, a speed reducer 27, a clutch 30, a driving shaft 35, a landing shaft 40, and a driving power transmission plate 52. The aircraft support body 11 serves to support a body of the aircraft in a state in which the aircraft body is spaced apart from the ground surface. The aircraft support body 11 includes a pair of motor mounting units 13 provided at a lower end of the aircraft support body 11. The aircraft support body 11 may be a column-shaped member extending along a vertical axis VL extending in an upward/downward direction. The pair of motor mounting units 13 is disposed symmetrically with respect to the vertical axis VL.

The aircraft support body 11 may be connected to a shock absorber configured to absorb a shock transmitted to the aircraft body when the aircraft lands. Alternatively, the aircraft support body 11 may be a component of the shock absorber. The aircraft body of the aircraft includes a fuselage and wings. The aircraft wheels 60 rolls in a state of being in contact with the ground surface and supports a load of the aircraft body. The aircraft wheel 60 includes an annular tire 61 made of rubber, and a tire support wheel 64 configured to fix and support the tire 61.

The tire support wheel 64 is made of metal and includes an annular tire fixing part 69 configured to fix and support an inner portion of the tire 61, and a wheel disc part 65 having a disc shape and configured to support the tire fixing part 69. The wheel disc part 65 has a hollow portion 67 formed through the wheel disc part 65 along a horizontal axis PL orthogonal to the vertical axis VL. To block foreign substances such as dust or wastewater that penetrate into the tire support wheel 64 from the outside of the aircraft wheel 60, a disc-shaped wheel cap 71 may be detachably coupled to the tire support wheel 64. The aircraft support body 11 and the aircraft wheels 60 constitute a landing gear of the aircraft.

The electric motor 75 is mounted in the motor mounting unit 13. The motor mounting unit 13 has a motor groove 14 into which the electric motor 75 is fitted. The motor mounting unit 13 has a harness through-hole 16 formed through the motor groove 14 and an outer peripheral surface of the motor mounting unit 13. The electric motor 75 includes a cylindrical motor body 76, and a motor shaft 79 extending and protruding outward from the motor body 76 along the horizontal axis PL. An outer peripheral surface of the motor body 76 fitted into the motor groove 14 may be in close contact with an inner peripheral surface of the motor groove 14.

The electric motor 75 further includes a motor flange 77 radially extending from the outer peripheral surface of the motor body 76. The motor flange 77 serves as a stopper configured to prevent the excessive insertion of the motor body 76 by being caught by a peripheral portion of an opening of the motor groove 14 when the electric motor 75 is fitted into the motor groove 14. A lower end of a harness 81 configured to supply electric power to the electric motor 75 enters the motor groove 14 through the harness through-hole 16 from the outside of the motor mounting unit 13 and is conductively connected to a terminal at a rear end of the motor body 76 of the electric motor 75. In embodiments, an upper end of the harness 81 is conductively connected to a terminal of the aircraft body.

The cover 20 is made of metal. The cover 20 is fixedly coupled to the motor mounting unit 13 and protects the electric motor 75. Specifically, the motor mounting unit 13 includes a flange portion 17 radially extending with respect to the horizontal axis PL. An annular rear end 21 of the cover 20 is fixedly coupled to the flange portion 17. Therefore, the motor shaft 79 is not exposed between the aircraft wheel 60 and the motor mounting unit 13.

The cover 20 includes a front end 23 spaced apart from the annular rear end 21, a tubular sidewall portion protruding from the annular rear end 21 toward the aircraft wheel 60 and connected to the front end 23, and a landing shaft coupling portion 26 supported on the front end 23. The speed reducer 27 and the clutch 30 are disposed in an internal space of the cover 20 defined by the tubular sidewall portion and the front end 23. A cover through-hole 24 is formed in the front end 23 and the landing shaft coupling portion 26 so that the driving shaft 35 penetrates the cover through-hole 24.

The driving shaft 35 is made of metal. The driving shaft 35 is rotated by the rotation of the motor shaft 79 of the electric motor 75. The driving shaft 35 penetrates the cover 20 and the tire support wheel 64. Specifically, the driving shaft 35 includes a disc-shaped disc portion 38 positioned in the cover 20, and a cylindrical portion 36 extending along the horizontal axis PL from the disc portion 38. The cylindrical portion 36 penetrates the cover 20 through the cover through-hole 24 and penetrates the tire support wheel 64 through the hollow portion 67.

The speed reducer 27 and the clutch 30 is disposed in the cover 20 and interposed between the electric motor 75 and the disc portion 38 of the driving shaft 35. The clutch 30 is selectively connected to the disc portion 38 of the driving shaft 35 and selectively transmits a rotational force of the motor shaft 79 to the driving shaft 35. The clutch 30 includes a central gear part 31 disposed on the horizontal axis PL, and a stack plate part 33 having a plurality of stacked plates disposed around the central gear part 31. As the plurality of plates of the stack plate part 33 come into friction contact with one another or move away from one another, the clutch 30 is connected to the disc portion 38 of the driving shaft 35 to transmit the rotational force or disconnected.

The speed reducer 27 is provided in the cover 20 and disposed between the electric motor 75 and the clutch 30. The speed reducer 27 serves to reduce a rotational speed of the motor shaft 79 and transmit the rotational force to the clutch 30. The speed reducer 27 may be a harmonic drive, for example. When the clutch 30 is not connected to the driving shaft 35, the driving shaft 35 does not rotate in conjunction with the motor shaft 79 even though the motor shaft 79 rotates. The clutch 30 is set to be connected to the driving shaft 35 in order for the self-taxiing apparatus 10 for an aircraft to operate and move the aircraft on the ground.

The clutch 30 is set not to be connected to the driving shaft 35 when the aircraft lands. Therefore, when the aircraft wheel 60 collides with the ground surface, impact applied to the aircraft wheel 60 is not transmitted to the clutch 30 through the driving shaft 35. Therefore, the clutch 30, the speed reducer 27, and the electric motor 75 are prevented from being damaged or abnormally operated by high impact applied when the aircraft lands.

The driving power transmission plate 52 has one end 53 fixedly coupled to the driving shaft 35, and the other end 55 fixedly coupled to the tire support wheel 64. The driving power transmission plate 52 transmits the rotational force of the driving shaft 35 to the aircraft wheel 60. Specifically, the cylindrical portion 36 of the driving shaft 35 penetrates the driving power transmission plate 52. A concave-convex portion 37 is formed on an outer peripheral surface of a distal end of the cylindrical portion 36 and stepped along a circular track around the horizontal axis PL. A hollow portion is formed at one end 53 of the driving power transmission plate 52, and the cylindrical portion 36 penetrates the hollow portion. A concave-convex portion 54 is formed and stepped on an inner peripheral surface of one end 53 of the driving power transmission plate 52 and engages with the concave-convex portion 37 formed on the outer peripheral surface of the distal end of the cylindrical portion 36.

The other end 55 of the driving power transmission plate 52 has a plate shape and is fixedly coupled to the wheel disc part 65 of the tire support wheel 64 by a plurality of fastening bolts. With this configuration, the aircraft wheel 60 rotates when the motor shaft 79 rotates as the electric motor 75 operates in the state in which the clutch 30 and the driving shaft 35 are connected to each other. That is, the aircraft may be moved on the ground by the power of the electric motor 75.

The landing shaft 40 supports the tire support wheel 64 by means of a pair of bearings 45 and 47 so that the tire support wheel 64 is rotatable. The landing shaft 40 includes a tubular portion 41 extending along the horizontal axis PL, and a flange portion 43 radially extending from a distal end of the tubular portion 41 adjacent to the electric motor 75. The tubular portion 41 surrounds the cylindrical portion 36 of the driving shaft 35 and extends while penetrating the tire support wheel 64 through the hollow portion 67. An inner diameter of the tubular portion 41 is larger than an outer diameter of the cylindrical portion 36 so that an inner peripheral surface of the tubular portion 41 is spaced apart from an outer peripheral surface of the cylindrical portion 36.

A length of the tubular portion 41 is shorter than a length of the cylindrical portion 36 so that the concave-convex portion 37 of the distal end of the cylindrical portion 36 may engage with the concave-convex portion 54 of one end 53 of the driving power transmission plate 52. The pair of bearings 45 and 47 includes first and second bearings 45 and 47. The first bearing 45 is interposed between an outer peripheral surface of an end of the tubular portion 41 adjacent to the wheel cap 71 and an inner peripheral surface that defines the hollow portion 67 of the tire support wheel 64. The second bearing 47 is interposed between an outer peripheral surface of an end of the tubular portion 41 adjacent to the flange portion 43 and the inner peripheral surface that defines the hollow portion 67 of the tire support wheel 64.

The flange portion 43 is fixedly coupled to the landing shaft coupling portion 26 of the cover 20 by a plurality of fastening bolts. Therefore, the motor mounting unit 13, the cover 20, and the landing shaft 40 do not rotate even though the driving shaft 35, the driving power transmission plate 52, and the aircraft wheel 60 rotate as the motor shaft 79 rotates in the state in which the driving shaft 35 is connected to the clutch 30.

A locking nut 50 is fixedly fastened to the end of the tubular portion 41 adjacent to the wheel cap 71 to prevent the pair of bearings 45 and 47 and the tire support wheel 64 supported on the pair of bearings 45 and 47 from moving along the horizontal axis PL and separating from the tubular portion 41 of the landing shaft 40. In more detail, unless the locking nut 50 is fixedly coupled to the tubular portion 41, the tire support wheel 64 and the pair of bearings 45 and 47, which has outer races fixed to and being in close contact with the inner peripheral surface of the hollow portion 67 of the tire support wheel 64, may move along the horizontal axis PL and separate from the tubular portion 41 of the landing shaft 40 while the aircraft wheel 60 rotates. In contrast, the locking nut 50 blocks the first bearing 45 and restricts the movements of the pair of bearings 45 and 47 and the tire support wheel 64 along the horizontal axis PL. Therefore, the aircraft wheel 60 does not separate from the landing shaft 40.

As described above, the clutch 30 is connected to the driving shaft 35 only when the aircraft moves on the ground. The clutch 30 is not connected to the driving shaft 35 when the aircraft lands. Therefore, impact, which is applied to the aircraft wheel 60 when the aircraft lands and the aircraft wheel 60 collides with the ground surface, is sequentially transmitted to the pair of bearings 45 and 47, the landing shaft 40, the cover 20, the motor mounting unit 13, and the aircraft support body 11.

Since the tubular portion 41 of the landing shaft 40 is separated and spaced apart from the cylindrical portion 36 of the driving shaft 35, the driving shaft 35 is not greatly affected by the impact applied to the landing shaft 40. Even though the impact applied to the landing shaft 40 is partially transmitted to the driving shaft 35, the impact transmitted to the driving shaft 35 is not transmitted to the clutch 30, the speed reducer 27, and the electric motor 75 because the driving shaft 35 is not connected to the clutch 30. Therefore, even though the aircraft repeatedly takes off and lands, a defective operation of and damage to the self-taxiing apparatus 10 for an aircraft are inhibited, and durability is improved.

Meanwhile, as illustrated in FIG. 4, the self-taxiing apparatus 10 for an aircraft includes a pair of motor mounting units 13, a pair of electric motors 75, a pair of covers 20, a pair of aircraft wheels 60, a pair of speed reducers 27, a pair of clutches 30, a pair of driving shafts 35, a pair of driving power transmission plates 52, and a pair of landing shafts 40. The pair of motor mounting units 13, the pair of electric motors 75, the pair of covers 20, the pair of aircraft wheels 60, the pair of speed reducers 27, the pair of clutches 30, the pair of driving shafts 35, the pair of driving power transmission plates 52, and the pair of landing shafts 40 may be disposed symmetrically with respect to the aircraft support body 11, particularly, the vertical axis VL. Therefore, the aircraft may stably move on the ground by using high driving power.

As described above, the self-taxiing apparatus 10 for an aircraft may move the aircraft on the ground by using the power of the electric motor 75 mounted in the aircraft without using a special vehicle such as a tug or towing car. Therefore, it is possible to prevent a delay of takeoff and landing of the aircraft in the airport even though the special vehicle is not available. In addition, the aircraft may be moved on the ground only by the power of the electric motor 75, which emits no environmental pollutants. Therefore, environmental pollution is inhibited.

According to the present disclosure, the electric motor is mounted in the motor mounting unit and protected by the cover. Further, the impact, which is applied to the aircraft wheel when the aircraft lands, is sequentially transmitted to the cover and the aircraft support body through the landing shaft but not transmitted to the electric motor through the driving shaft. As a result, even though the aircraft repeatedly takes off and lands, a defective operation of and damage to the self-taxiing apparatus for an aircraft are inhibited, and durability is improved.

While the present disclosure has been described with reference to the example embodiment depicted in the drawings, the example embodiment is described just for illustration, and those skilled in the art to the present technology pertains will understand that various modifications of the example embodiment and any other example embodiment equivalent thereto are available. Accordingly, the true protection scope of the present disclosure should be determined by the appended claims.

What is claimed is:

1. A self-taxiing apparatus for an aircraft, the self-taxiing apparatus comprising:
an aircraft support body configured to support a body of an aircraft in a state in which the body of the aircraft is spaced apart from a ground surface, the aircraft support body having a motor mounting unit provided at a lower end thereof;
an electric motor mounted in the motor mounting unit;
a cover fixedly coupled to the motor mounting unit and configured to protect the electric motor;
an aircraft wheel configured to roll in a state of being in contact with the ground surface, the aircraft wheel comprising an annular tire and a tire support wheel configured to fix and support the tire;
a driving shaft configured to be rotated by a rotation of a motor shaft of the electric motor, the driving shaft being configured to penetrate the cover and the tire support wheel;
a driving power transmission plate having one end fixedly coupled to the driving shaft and the other end fixedly coupled to the tire support wheel, the driving power transmission plate being configured to transmit a rotation of the driving shaft to the aircraft wheel; and
a landing shaft configured to support the tire support wheel by means of a bearing so that the tire support wheel is rotatable, the landing shaft being fixedly coupled to the cover and configured not to rotate despite the rotation of the driving shaft.

2. The self-taxiing apparatus of claim 1, wherein the landing shaft comprises a tubular portion configured to surround the driving shaft, extending while penetrating the tire support wheel, and separated from the driving shaft and the driving power transmission plate, and
wherein the bearing is interposed between an outer peripheral surface of the tubular portion and an inner peripheral surface of a hollow portion formed in the tire support wheel so that the landing shaft penetrates the hollow portion.

3. The self-taxiing apparatus of claim 2, wherein impact, which is applied to the aircraft wheel when the aircraft lands and the aircraft wheel collides with the ground surface, is sequentially transmitted to the bearing, the landing shaft, the cover, and the motor mounting unit but not transmitted to the electric motor through the driving shaft.

4. The self-taxiing apparatus of claim 3, further comprising:
a clutch disposed in the cover and configured to be selectively connected to the driving shaft and selectively transmit a rotational force of the motor shaft to the driving shaft,
wherein the clutch is not connected to the driving shaft when the aircraft lands, such that the impact applied to the aircraft wheel is not transmitted to the clutch through the driving shaft.

5. The self-taxiing apparatus of claim 4, further comprising:
a speed reducer provided in the cover, disposed between the electric motor and the clutch, and configured to reduce a rotational speed of the motor shaft.

6. The self-taxiing apparatus of claim 1, wherein a concave-convex portion is formed on an outer peripheral surface of one end of the driving shaft, and a concave-convex portion is formed on an inner peripheral surface of one end of the driving power transmission plate and engages with the concave-convex portion formed on the outer peripheral surface of the driving shaft, such that the driving shaft and the driving power transmission plate are coupled to each other by means of a spline structure.

7. The self-taxiing apparatus of claim 1, wherein the motor mounting unit comprises:
a motor groove into which the electric motor is fitted; and
a harness through-hole formed through the motor groove and an outer peripheral surface of the motor mounting unit, and
wherein a harness configured to supply electric power to the electric motor enters the motor groove through the harness through-hole from the outside of the motor mounting unit and is conductively connected to the electric motor.

8. The self-taxiing apparatus of claim 1, wherein the aircraft support body has a pair of motor mounting units, and a pair of electric motors, a pair of covers, a pair of aircraft wheels, a pair of driving shafts, a pair of driving power transmission plates, and a pair of landing shafts are symmetrically provided with respect to the aircraft support body.
